(19) United States
(12) Patent Application Publication
(10) Pub. No.: US 2025/0180688 A1
(43) Pub. Date: Jun. 5, 2025

(54) A METHOD AND DEVICE FOR ANGULAR POSITIONING

(71) Applicant: Sony Group Corporation, Tokyo (JP)

(72) Inventors: Fredrik RUSEK, Eslöv (SE); Jose FLORDELIS, Lund (SE); Chaitanya TUMULA, Åkarp (SE); Kun ZHAO, Malmö (SE); Olof ZANDER, Södra Sandby (SE); Erik BENGTSSON, Eslöv (SE)

(21) Appl. No.: 18/843,256

(22) PCT Filed: Feb. 14, 2023
(86) PCT No.: PCT/EP2023/053670

§ 371 Date: Sep. 1, 2024

(30) Foreign Application Priority Data
Mar. 14, 2022 (SE) 2250322-1

(51) Int. Cl. G01S 3/14; H04L 5/00; H04W 64/00

(52) U.S. Cl. CPC G01S 3/143; H04L 5/0048; H04W 64/006

(57) ABSTRACT

A method, performed by a network node, may be provided. The method comprises transmitting, to a wireless device, control signalling indicating to the wireless device that, upon receiving a downlink signal from the network node, the wireless device is to respond by transmitting an uplink signal. The downlink signal may comprise a first downlink polarisation and a second downlink polarisation. The uplink signal may comprise a first uplink polarisation and a second uplink polarisation. The downlink signal may have a measured downlink characteristic. The measured downlink characteristic may comprise a downlink amplitude ratio between the amplitude of the downlink signal in the first downlink polarisation and the amplitude of the downlink signal in the second downlink polarisation.

The present disclosure pertains to the field of wireless communications. The present disclosure relates to methods for angular positioning and related devices.

### BACKGROUND

In New Radio, NR, millimeter-wave, the network node (such as a gNB) should ideally select a narrow high gain beam to the wireless device (such as a User Equipment, UE). However, finding such narrow beam of the wireless device is a difficult task.

### SUMMARY

In other words, finding a narrow beam of the wireless device can be seen as finding the direction to the wireless device from the network node. Finding the direction to the wireless device from the network node may be seen as an angular positioning of the wireless device with respect to the network node. For example, when the network node transmits L signals or beams, (where L may be less than 20, such as less than 10), a high precision angular positioning from the received signals at the wireless device may be needed.

Accordingly, there may be a need for devices and methods, which may mitigate, alleviate, or address the existing shortcomings and may provide high precision angular positioning from the received signals at the wireless device.

A method, performed by a network node, may be provided. The method comprises transmitting, to a wireless device, control signalling indicating to the wireless device that, upon receiving a downlink signal from the network node, the wireless device is to respond by transmitting an uplink signal. The downlink signal may comprise a first downlink polarisation and a second downlink polarisation. The uplink signal may comprise a first uplink polarisation and a second uplink polarisation. The downlink signal may have a measured downlink characteristic. The measured downlink characteristic may comprise a downlink amplitude ratio between the amplitude of the downlink signal in the first downlink polarisation and the amplitude of the downlink signal in the second downlink polarisation. The measured downlink characteristic may comprise a downlink phase difference between the phase of the downlink signal in the first downlink polarisation and the phase of the downlink signal in the second downlink polarisation. The uplink signal may have a transmitted uplink characteristic. The transmitted uplink characteristic may comprise an uplink amplitude ratio between the amplitude of the uplink signal in the first uplink polarisation and the amplitude of the uplink signal in the second uplink polarisation. The transmitted uplink characteristic may comprise an uplink phase difference between the phase of the uplink signal in the first uplink polarisation and the phase of the uplink signal in the second uplink polarisation. The transmitted uplink characteristic may be the same as the measured downlink characteristic.

The method may be advantageous in that it may enable the network node to accurately estimate or determine the angular positioning of the wireless device. By means of the control signalling, the network node may configure the wireless device to, upon receiving the downlink signal from the network node, respond by transmitting the uplink signal. Since the control signalling may indicate to the wireless device that the transmitted uplink characteristic of the uplink signal is to be the same as the measured downlink characteristic of the downlink signal, the network node may benefit from such characteristic to perform such accurate estimation or determination of the angular positioning of the wireless device. For example, the characteristic may comprise one or more of: the amplitude ratio between the amplitude of the signal in the first polarisation and the amplitude of the signal in the second polarisation, and the phase difference between the phase of the signal in the first polarisation and the phase of the signal in the second polarisation. Finding the direction to the wireless device from the network node can find applications in many areas.

The disclosed method performed by the network node may lead to an improved communication between the wireless device and the network node, such as an improved Signal-to-Noise Ratio, SNR, and/or an improved Signal-to-Interference plus Noise Ratio, SINR.

The method may be beneficial to enable a precise estimation or determination of the angular positioning of the wireless device that does not necessarily involve a significant overhead, as it might not require to rely on scanning a large number of narrow beams in order for the wireless device to report the best narrow beam or to rely on scanning several narrow beams within a previously selected wide beam (which may be selected from a previous scan of several wide beams). A more precise angular positioning may be ensured even if the number (such as L) of uplink and downlink signals is limited. The method may enable a precise estimation or determination of the angular positioning of the wireless device even in the presence of a poor Signal-to-Noise Ratio, SNR.

A network node comprising memory circuitry, processor circuitry, and a wireless interface may be provided. The network node is configured to perform any of the methods disclosed herein. Therefore, the network node may be advantageous for the same reasons as set forth for such methods.

Further, a method, performed by a wireless device, may be provided. The method comprises receiving, from a network node, control signalling indicating that, upon receiving a downlink signal from the network node, the wireless device is to respond by transmitting an uplink signal. The downlink signal may comprise a first downlink polarisation and a second downlink polarisation. The uplink signal may comprise a first uplink polarisation and a second uplink polarisation. The downlink signal may have a measured downlink characteristic. The measured downlink characteristic may comprise a downlink amplitude ratio between the amplitude of the downlink signal in the first downlink polarisation and the amplitude of the downlink signal in the second downlink polarisation. The measured downlink characteristic may comprise a downlink phase difference between the phase of the downlink signal in the first downlink polarisation and the phase of the downlink signal in the second downlink polarisation. The uplink signal may have a transmitted uplink characteristic. The transmitted uplink characteristic may comprise an uplink amplitude ratio between the amplitude of the uplink signal in the first uplink polarisation and the amplitude of the uplink signal in the second uplink polarisation. The transmitted uplink characteristic may comprise an uplink phase difference between the phase of the uplink signal in the first uplink polarisation and the phase of the uplink signal in the second uplink polarisation. The transmitted uplink characteristic may be the same as the measured downlink characteristic.

A wireless device comprising memory circuitry, processor circuitry, and a wireless interface may be provided. The wireless device is configured to perform any of the methods disclosed herein.

The disclosed method performed by the wireless device and the disclosed wireless device may be advantageous for the same reasons as set forth for the disclosed method performed by the network node and the disclosed network node, that is, by relying on the properties of the control signalling discussed herein.

The disclosed method performed by the wireless device and the disclosed wireless device may lead to an improved communication between the wireless device and the network node, such as an improved Signal-to-Noise Ratio, SNR, and/or an improved Signal-to-Interference plus Noise Ratio, SINR.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a signalling diagram illustrating an example communication between a network node and a wireless device, according to this disclosure,

FIG. 3 is a flow-chart illustrating an example method, performed in a network node of a wireless communication system, according to this disclosure,

FIG. 4 is a flow-chart illustrating an example method, performed in a wireless device, according to this disclosure,

FIG. 5 is a block diagram illustrating an example wireless device according to this disclosure,

FIG. 6 is a block diagram illustrating an example network node according to this disclosure, and

FIGS. 7A-7B are graphs illustrating example performances of the angular positioning of the wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

Finding the direction to the wireless device from the network node may be seen as an angular positioning of the wireless device with respect to the network node.

One approach can be to scan all available narrow beams and to have the wireless device report the best beam. Another approach can be to first scan several wide beams, to have the wireless device report the best beam, to have the network node select the best beam (which is a wide beam) and, then to scan several narrow beams within an angle covered by the selected wide beam. These approaches may involve considerable overhead when an increased accuracy in the determination or estimation of the angular positioned is targeted.

In legacy systems, the wireless device receives, from the network node, L signals. For a wireless device with dually polarised antennas, the wireless device receives 2L signals over dual polarisations, wherein each received signal of the L signals is associated with a first and a second polarisation of the wireless device. In other words, for example, each received signal has two components, one per polarisation. The wireless device reports the Reference Signal Received Power, RSRP, of all, or a subset, of the beams. In the case of a subset, the strongest beams are to be reported. For example, the wireless device reports measurements proportional to the absolute power of the received signals in the l:th beam in the first and second polarisation of the wireless device. Since only power is to be reported, there is no need to report any difference in polarisation coordinate systems between the network node and the wireless device. However, the RSRP information leads to a coarse angular positioning (e.g. less accurate angular positioning than that of the provided methods and devices) for a same number of scanning beams.

An estimation of the angular positioning of the wireless device may be achieved when Channel State Information, CSI, is provided to the network node. For example, CSI-Reference Signal (CSI-RS) transmissions may support the network node in acquiring CSI.

However, when CSI is not obtained to the network node, the network node can use relative power differences as a basis for angular positioning and, in such case, the angular positioning of the wireless device might not be unambiguously determined or estimated. In other words, this approach can provide the network node with more than one positioning estimate for the wireless device. Selecting the wrong estimate can lead to a degradation in the communication performance.

The present disclosure looks to determine accurate angular positioning after the first scan of wide beams. During a beam sweep from the network node, the signals received at the wireless device can be used for angular positioning of the wireless device. It may be appreciated that the beams can be constructed in such a way that their polarisation properties vary, in a controlled manner, across the angle of departure at the network node. This may lead to more information being available to enable a more precise angular positioning accordingly to this disclosure.

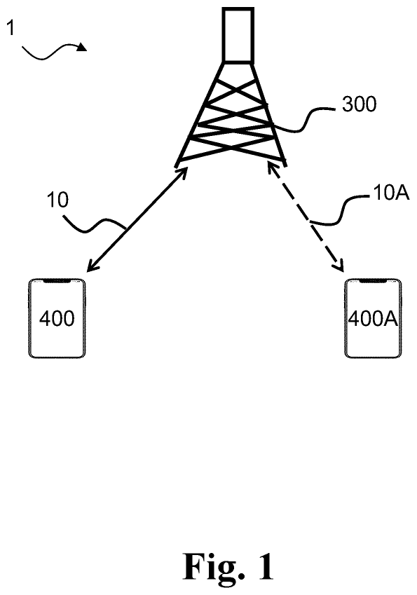

FIG. 1 is a diagram illustrating an example wireless communication system 1 comprising an example network node 300 and an example wireless device 400 according to this disclosure.

As discussed in detail herein, the present disclosure relates to a wireless communication system 1 comprising a cellular system, for example, a 3GPP wireless communication system. The wireless communication system 1 comprises a wireless device 400 and/or a network node 300.

A network node disclosed herein refers to a radio access network node operating in the radio access network, such as a base station, an evolved Node B, eNB, gNB in NR. In one or more examples, the RAN node is a functional unit which may be distributed in several physical units.

The wireless communication system 1 described herein may comprise one or more wireless devices 400, 400A, and/or one or more network nodes 300, such as one or more of: a base station, an eNB, a gNB and/or an access point.

A wireless device may refer to a mobile device and/or a user equipment, UE.

The wireless device 400, 400A may be configured to communicate with the network node 300 via a wireless link (or radio access link) 10, 10A respectively.

The present disclosure involves downlink and uplink transmissions.

For example, for downlink transmissions, a network node 300 is equipped with M dually polarised antennas and L sets of beamforming coefficients to be applied at said M dually polarised antennas.

For example, the network node 300 can communicate with a dually polarised wireless device 400 located at a direction α=(φ,θ) in relation to the network node 300, where φ is azimuth angle and θ is elevation angle. For example, for the signal transmitted using the l:th beam from the network node 300, the wireless device 400 receives the first and the second polarisations of this signal, which may be expressed as:

$${y}_{l} = [ \begin{matrix}{y}_{1 , l} \\ {y}_{2 , l}\end{matrix} ] = γ R ( β ) [ \begin{matrix}{B}_{1 , l} ( α ) & 0 \\ 0 & {B}_{2 , l} ( α )\end{matrix} ] [ \begin{matrix}{p}_{1 , l} \\ {p}_{2 , l}\end{matrix} ] + [ \begin{matrix}{n}_{1 , l} \\ {n}_{2 , l}\end{matrix} ] \qquad ( 1 )$$

where y_{1,l} and y_{2,l} denote the received signals in the first and second polarisation of the wireless device 400, respectively;
γ denotes a complex valued channel gain (which can be considered unknown or known to an angular positioning estimator);
R(β) denotes a rotation matrix by angle β, which can account for a difference in polarisation coordinate systems between the network node 300 and the wireless device 400;
B_{1,l}(α) denotes a transmit antenna port response of the l:th beam in direction α in the first polarisation with respect to the coordinate system at the network node 300;
B_{2,l}(α) denotes a transmit antenna port response of the l:th beam in direction α in the second polarisation with respect to the coordinate system at the network node 300;
p_{1,l} and p_{2,l} denote transmit signals from the network node 300 in the l:th beam in the first and second polarisation, respectively; and
n_{k,l} denote noise parameters which are modelled as zero-mean complex Gaussian with variance N₀, wherein k denotes the polarisation referring to the first or the second polarisation.

For example, for the uplink transmission, the input-output relation of the channel is the transpose of the input-output relation of the channel of the downlink transmission. For example, the received uplink signal may be expressed as:

$${r}_{l} = [ \begin{matrix}{r}_{1 , l} \\ {r}_{2 , l}\end{matrix} ] = γ [ \begin{matrix}{B}_{1 , l} ( α ) & 0 \\ 0 & {B}_{2 , l} ( α )\end{matrix} ] {R}^{T} ( β ) [ \begin{matrix}{s}_{1 , l} \\ {s}_{2 , l}\end{matrix} ] + [ \begin{matrix}{w}_{1 , l} \\ {w}_{2 , l}\end{matrix} ] \qquad ( 2 )$$

where r_{1,l} and r_{2,l} may denote the received uplink signals in the l:th beam in the first and second polarisation of the network node 300, respectively;
s_{1,l} and s_{2,l} may denote transmit signals from the wireless device 400 associated with the l:th beam in the first and second polarisation, respectively; and
w_{k,l} denote noise parameters, wherein the noise density may be the same for the uplink transmission and for the downlink transmission, and wherein k may denote the polarisation referring to the first or the second polarisation.

During a beam sweep from the network node 300, the signals received at the wireless device 400 can be used for angular positioning of the wireless device 400. It may be appreciated that the beams can be constructed in such a way that their polarisation properties vary, in a controlled manner, across the angle of departure at the network node 300. This may lead to more information available to enable a more precise angular positioning accordingly to this disclosure.

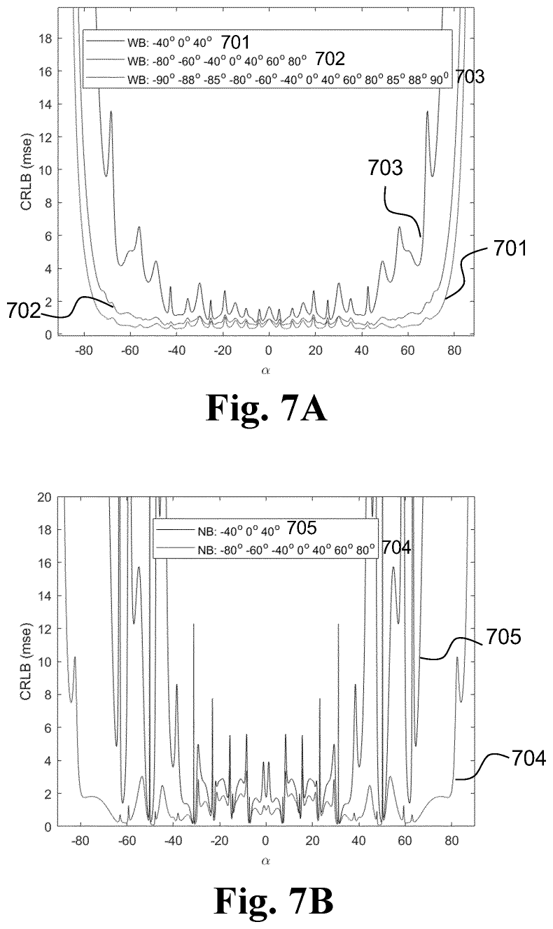

The present disclosure provides a control signalling that may enable an improved precision of angular positioning of the wireless device 400. The network node 300 disclosed herein can determine an angular positioning of the wireless device based on the transmitted uplink characteristic of the uplink signal. The disclosed example beam construction can lead to improved performance, which are illustrated in example numerical results of FIGS. 7A-7B.

For example, more information than only Reference Signal Received Power, RSRP, information is provided as feedback to the network node 300 to improve angular positioning.

In one or more examples, in response to the l:th received downlink signal, the wireless device 400 transmits uplink signals, comprising a first and a second polarisation, that may be expressed as e.g.:

$$[ \begin{matrix}{s}_{1 , l} \\ {s}_{2 , l}\end{matrix} ] = [ \begin{matrix}{y}_{1 , l} \\ {y}_{2 , l}\end{matrix} ] \qquad ( 3 )$$

For example, stated differently, the wireless device 400 transmits an uplink signal having characteristics which are the same as the measured downlink characteristics of the received downlink signal. The received uplink signal at the network node 300 can be expressed as, e.g.:

$${r}_{l} = γ [ \begin{matrix}{B}_{1 , l} ( α ) & 0 \\ 0 & {B}_{2 , l} ( α )\end{matrix} ] {R}^{T} ( β ) [ γ R ( β ) [ \begin{matrix}{B}_{1 , l} ( α ) & 0 \\ 0 & {B}_{2 , l} ( α )\end{matrix} ] [ \begin{matrix}{p}_{1 , l} \\ {p}_{2 , l}\end{matrix} ] + [ \begin{matrix}{n}_{1 , l} \\ {n}_{2 , l}\end{matrix} ] ] + [ \begin{matrix}{w}_{1 , l} \\ {w}_{2 , l}\end{matrix} ] \qquad ( 4 )$$

This can be expressed as for example:

$${r}_{l} = {γ}^{2} [ \begin{matrix}{B}_{1 , l}^{2} ( α ) & 0 \\ 0 & {B}_{2 , l}^{2} ( α )\end{matrix} ] [ \begin{matrix}{p}_{1 , l} \\ {p}_{2 , l}\end{matrix} ] + [ \begin{matrix}{z}_{1 , l} \\ {z}_{2 , l}\end{matrix} ] \qquad ( 5 )$$

where

$$[ \begin{matrix}{z}_{1 , l} \\ {z}_{2 , l}\end{matrix} ]$$

denotes a zero-mean complex Gaussian noise vector with covariance matrix, for example:

$${C}_{l} ( γ , α ) = {N}_{0} [ I + {\vert γ \vert}^{2} [ \begin{matrix}{\vert {B}_{1 , l} ( α ) \vert}^{2} & 0 \\ 0 & {\vert {B}_{2 , l} ( α ) \vert}^{2}\end{matrix} ] ] . \qquad ( 6 )$$

It can be noted that the wireless device 400 might not feedback the uplink signals {y_{1,l},y_{2,l}}ₗ₌₁^{L} over an auxiliary channel, but may rather transmit the uplink signals over the physical channel. In other words, the uplink signals received by the network node 300 may not be noise-free.

The network node 300 can, based on the signals {rₗ}ₗ₌₁^{L}, estimate a by estimation techniques.

The estimation techniques can be as disclosed herein and/or any other available to the person skilled in the art. A maximum likelihood estimator can provide an estimate of the angular positioning of the wireless device, which can be expressed for example as:

$$\hat{α} = arg {min}_{α} {\sum }_{l = 1}^{L} log ( 1 + {\vert γ \vert}^{2} {\vert {B}_{1 , l} ( α ) \vert}^{2} ) + log ( 1 + {\vert γ \vert}^{2} {\vert {B}_{1 , l} ( α ) \vert}^{2} ) + {( {r}_{l} - {γ}^{2} [ \begin{matrix}{B}_{1 , l}^{2} ( α ) & 0 \\ 0 & {B}_{2 , l}^{2} ( α )\end{matrix} ] [ \begin{matrix}{p}_{1 , l} \\ {p}_{2 , l}\end{matrix} ] )}^{H} {C}_{l}^{- 1} ( γ , α ) ( {r}_{l} - {γ}^{2} [ \begin{matrix}{B}_{1 , l}^{2} ( α ) & 0 \\ 0 & {B}_{2 , l}^{2} ( α )\end{matrix} ] [ \begin{matrix}{p}_{1 , l} \\ {p}_{2 , l}\end{matrix} ] ) \qquad ( 7 )$$

In Equation (7), γ is considered known.

$$\hat{α} = arg {min}_{α} {min}_{γ} {\sum }_{l = 1}^{L} log ( 1 + {\vert γ \vert}^{2} {\vert {B}_{1 , l} ( α ) \vert}^{2} ) + log ( 1 + {\vert γ \vert}^{2} {\vert {B}_{1 , l} ( α ) \vert}^{2} ) + {( {r}_{l} - {γ}^{2} [ \begin{matrix}{B}_{1 , l}^{2} ( α ) & 0 \\ 0 & {B}_{2 , l}^{2} ( α )\end{matrix} ] [ \begin{matrix}{p}_{1 , l} \\ {p}_{2 , l}\end{matrix} ] )}^{H} {C}_{l}^{- 1} ( γ , α ) ( {r}_{l} - {γ}^{2} [ \begin{matrix}{B}_{1 , l}^{2} ( α ) & 0 \\ 0 & {B}_{2 , l}^{2} ( α )\end{matrix} ] [ \begin{matrix}{p}_{1 , l} \\ {p}_{2 , l}\end{matrix} ] ) \qquad ( 8 )$$

Equations (7) and (8) may be seen as differing only by a minimisation over γ.

The minimisations can be solved by calculating the cost function for a grid of values α, identifying the minimum, calculating the cost for a grid around the minimum, and optionally reiterating. For example, the minimisation over γ can be solved with line search.

It may be noted that the distance between the wireless device 400 and the network node 300 does not need to be estimated.

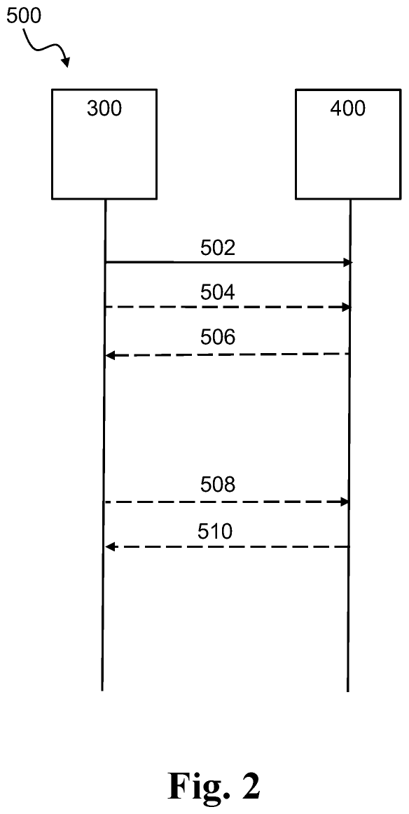

FIG. 2 is a signalling diagram 500 illustrating an example communication between a network node and a wireless device, according to this disclosure.

The network node 300 transmits, to the wireless device 400, control signalling 502 indicating to the wireless device that, upon receiving a downlink signal 504 from the network node, the wireless device 400 is to respond by transmitting an uplink signal 506. The wireless device 400 receives, from the network node 300, the downlink signal 504.

The downlink signal 504 may comprise a first downlink polarisation and a second downlink polarisation. The downlink signal 504 may have a measured downlink characteristic. The measured downlink characteristic may comprise a downlink amplitude ratio between the amplitude of the downlink signal in the first downlink polarisation and the amplitude of the downlink signal in the second downlink polarisation. The measured downlink characteristic may comprise a downlink phase difference between the phase of the downlink signal in the first downlink polarisation and the phase of the downlink signal in the second downlink polarisation. For example, the received downlink signal 504 may be expressed as: y_{1,1} and y_{2,1}.

The wireless device 400 transmits, to the network node 300, an uplink signal 506. The uplink signal 506 may have a transmitted uplink characteristic. The transmitted uplink characteristic may comprise an uplink amplitude ratio between the amplitude of the uplink signal in the first uplink polarisation and the amplitude of the uplink signal in the second uplink polarisation. The transmitted uplink characteristic may comprise an uplink phase difference between the phase of the uplink signal in the first uplink polarisation and the phase of the uplink signal in the second uplink polarisation. The transmitted uplink characteristic may be the same as the measured downlink characteristic. For example, the received uplink signal 506 may be expressed as: r_{1,1} and r_{2,1}.

The network node 300 can determine an angular positioning of the wireless device based on the transmitted uplink characteristic of the uplink signal 506. In other words, the control signalling 502 enables the network node 300 to obtain an accurate estimation or determination of the angular positioning of the wireless device 400.

It may be envisaged that the control signalling 502 indicates to the wireless device 400 that, upon receiving a plurality of downlink signals, comprising the downlink signal 504, from the network node 300, the wireless device 400 is to respond by transmitting a plurality of uplink signals, comprising the uplink signal 506, each uplink signal of the plurality of uplink signals being associated with a corresponding downlink signal of the plurality of downlink signals.

For example, the network node 300 can transmit a plurality of downlink signals (such as L downlink signals, such as l:th downlink signal 508). For a wireless device with dually polarised antennas, the wireless device receives 2L downlink signals over the dual polarisations. For example, each downlink signal comprises a first downlink polarisation and a second downlink polarisation. For example, each downlink signal has a measured downlink characteristic. For example, the measured downlink characteristic comprises a downlink amplitude ratio between the amplitude of the downlink signal in the first downlink polarisation and the amplitude of the downlink signal in the second downlink polarisation. For example, the measured downlink characteristic comprises a downlink phase difference between the phase of the downlink signal in the first downlink polarisation and the phase of the downlink signal in the second downlink polarisation. For example, the plurality of downlink signals (such as L downlink signals, such as l:th downlink signal 508) may be expressed as: {y_{1,l}}ₗ₌₁^{L} and {y_{2,l}}ₗ₌₁^{L}.

The wireless device 400 transmits, to the network node 300, a plurality of uplink signals (such as L uplink signals, such as l:th uplink signal 510). For a wireless device with dually polarised antennas, the wireless device transmits 2L uplink signals over dual polarisations. For example, each uplink signal comprises a first uplink polarisation and a second uplink polarisation. For example, each uplink signal has a transmitted uplink characteristic. For example, the transmitted uplink characteristic comprises an uplink amplitude ratio between the amplitude of the uplink signal in the first uplink polarisation and the amplitude of the uplink signal in the second uplink polarisation. For example, the transmitted uplink characteristic comprises an uplink phase difference between the phase of the uplink signal in the first uplink polarisation and the phase of the uplink signal in the second uplink polarisation. For example, the transmitted uplink characteristic of each uplink signal is the same as the measured downlink characteristic of the corresponding downlink signal. For example, plurality of uplink signals (such as L uplink signals, such as l:th uplink signal 510) may be expressed as: {r_{1,l}}ₗ₌₁^{L} and {r_{2,l}}ₗ₌₁^{L}.

The network node 300 can determine an angular positioning of the wireless device based on the transmitted uplink characteristics of the uplink signals from the wireless device 400.

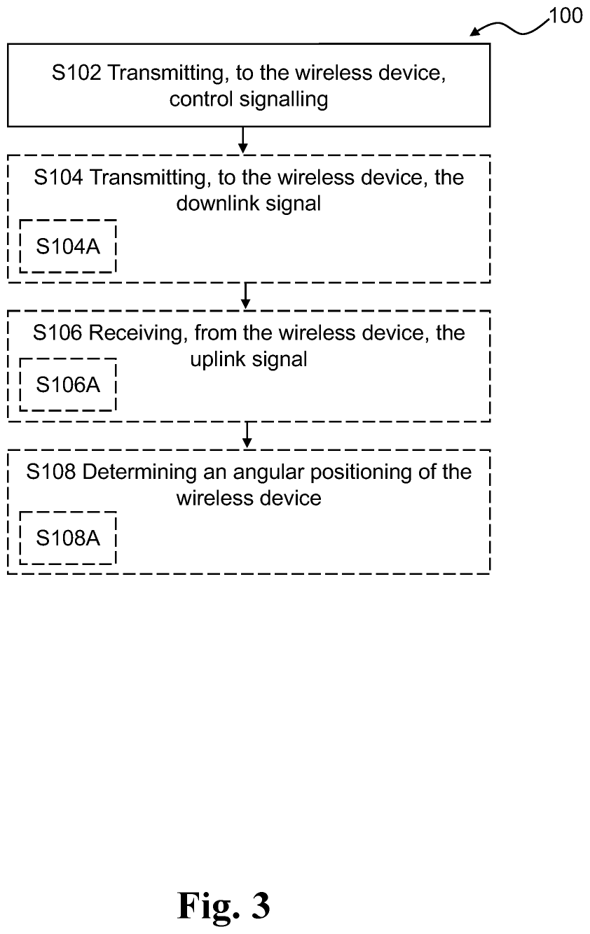

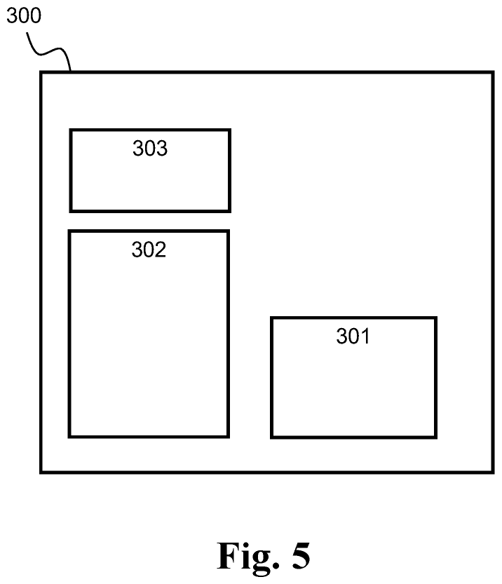

FIG. 3 shows a flow diagram of an example method 100, performed by a network node. The network node is the network node disclosed herein, such as network node 300 of FIG. 1, FIG. 2 and FIG. 5. The method 100 may be a method for angular positioning of a wireless device, such as for enabling angular positioning of a wireless device.

The method 100 comprises transmitting S102, to a wireless device, control signalling indicating to the wireless device that, upon receiving a downlink signal from the network node, the wireless device is to respond by transmitting an uplink signal. In one or more examples, the control signalling transmitted in S102 can be illustrated by 502 in FIG. 2.

Control signalling can be in the form of one or more of: a flag and one or more control messages. For example, the flag may be seen as an implicit signalling indicating to the wireless device that, upon receiving a downlink signal from the network node, the wireless device is to respond by transmitting an uplink signal. The one or more control messages can be indicating to the wireless device that, upon receiving a downlink signal from the network node, the wireless device is to respond by transmitting an uplink signal. The one or more control messages can include an information indicating to the wireless device that, upon receiving a downlink signal from the network node, the wireless device is to respond by transmitting an uplink signal.

The downlink signal may comprise a first downlink polarisation and a second downlink polarisation. In other words, the downlink signal may have a first downlink polarisation and a second downlink polarisation. The uplink signal may comprise a first uplink polarisation and a second uplink polarisation. Stated differently, the uplink signal may have a first uplink polarisation and a second uplink polarisation. For example, the network node can transmit the downlink signal in a first downlink polarisation and in a second downlink polarisation. For example, the wireless device can transmit the uplink signal in a first uplink polarisation and in a second uplink polarisation.

The downlink signal may have a measured downlink characteristic. The measured downlink characteristic may be seen as a characteristic, measured by the wireless device, performed on the downlink signal received by the wireless device. For example, the measured downlink characteristic is a characteristic representative of the downlink signal received by the wireless device. A signal (such as a downlink signal and/or an uplink signal) can include an amplitude and a phase.

The measured downlink characteristic may comprise a downlink amplitude ratio between the amplitude of the downlink signal in the first downlink polarisation and the amplitude of the downlink signal in the second downlink polarisation. The measured downlink characteristic may comprise a downlink phase difference between the phase of the downlink signal in the first downlink polarisation and the phase of the downlink signal in the second downlink polarisation.

The uplink signal may have a transmitted uplink characteristic. The transmitted uplink characteristic may be seen as a characteristic of the uplink signal transmitted by the wireless device. For example, the transmitted uplink characteristic is a characteristic representative of the uplink signal transmitted by the wireless device.

The transmitted uplink characteristic may comprise an uplink amplitude ratio between the amplitude of the uplink signal in the first uplink polarisation and the amplitude of the uplink signal in the second uplink polarisation. The transmitted uplink characteristic may comprise an uplink phase difference between the phase of the uplink signal in the first uplink polarisation and the phase of the uplink signal in the second uplink polarisation.

The transmitted uplink characteristic may be the same as the measured downlink characteristic. For example, the transmitted uplink characteristic may be substantially (such as +/−10%, such as +/−20%) the same as the measured downlink characteristic.

The method may enable an estimation or determination of the angular positioning of the wireless device by configuring the wireless device to, upon receiving one or more downlink signals from the network node, respond by transmitting one or more uplink signals.

In one or more example methods, the control signalling indicates to the wireless device that, upon receiving a plurality of downlink signals, comprising the downlink signal, from the network node, the wireless device is to respond by transmitting a plurality of uplink signals, comprising the uplink signal, each uplink signal of the plurality of uplink signals being associated with a corresponding downlink signal of the plurality of downlink signals.

For example, the plurality of downlink signals comprises a first downlink signal, a second downlink signal, and optionally a third downlink signal, and optionally a fourth downlink signal, and optionally a l:th downlink signal. L is a positive integer. For example, the plurality of uplink signals comprises a first uplink signal, a second uplink signal, and optionally a third uplink signal, and optionally a fourth uplink signal, and optionally a l:th uplink signal. L is a positive integer.

In one or more example methods, the control signalling indicates to the wireless device that, upon receiving a plurality of downlink signals from the network node, the wireless device is to respond by transmitting a plurality of uplink signals, each uplink signal of the plurality of uplink signals being associated with a corresponding downlink signal of the plurality of downlink signals.

Each downlink signal may comprise a first downlink polarisation and a second downlink polarisation. Each uplink signal may comprise a first uplink polarisation and a second uplink polarisation. Each downlink signal may have a first downlink polarisation and a second downlink polarisation. Each uplink signal may have a first uplink polarisation and a second uplink polarisation.

Each downlink signal may have a measured downlink characteristic. The measured downlink characteristic may comprise a downlink amplitude ratio between the amplitude of the downlink signal in the first downlink polarisation and the amplitude of the downlink signal in the second downlink polarisation. The measured downlink characteristic may comprise a downlink phase difference between the phase of the downlink signal in the first downlink polarisation and the phase of the downlink signal in the second downlink polarisation.

Each uplink signal may have a transmitted uplink characteristic. The transmitted uplink characteristic may comprise an uplink amplitude ratio between the amplitude of the uplink signal in the first uplink polarisation and the amplitude of the uplink signal in the second uplink polarisation. The transmitted uplink characteristic may comprise an uplink phase difference between the phase of the uplink signal in the first uplink polarisation and the phase of the uplink signal in the second uplink polarisation.

The transmitted uplink characteristic of each uplink signal may be the same as the measured downlink characteristic of the corresponding downlink signal. For example, the transmitted uplink characteristic may be substantially (such as +/−10%, such as +/−20%) the same as the measured downlink characteristic.

In one or more example methods, the method 100 comprises transmitting S104, to the wireless device, the downlink signal. For example, the network node may transmit, to the wireless device, the downlink signal in the first downlink polarisation and in the second downlink polarisation using one or more beams.

In one or more example methods, the method 100 comprises receiving S106, from the wireless device, the uplink signal. For example, the wireless device may transmit, to the network node, the uplink signal in the first uplink polarisation and in the second uplink polarisation using one or more beams.

In one or more example methods, the method 100 comprises determining S108 the angular positioning of the wireless device based on the transmitted uplink characteristic of the uplink signal.

The angular positioning of a wireless device may be seen as an angle formed by the direction towards the network node, such as one or more of: an azimuth angle and an elevation angle towards the network node.

In one or more example methods, the method 100 comprises transmitting S104A, to the wireless device, the plurality of downlink signals. For example, the network node may transmit, to the wireless device, each downlink signal of the plurality of downlink signals in the corresponding first downlink polarisation and in the corresponding second downlink polarisation using a corresponding beam. For example, the plurality of beams comprises a first beam, a second beam, and optionally a third beam, and optionally a fourth beam, and optionally an l:th beam. For example, a downlink signal can be transmitted in the corresponding first downlink polarisation and in the corresponding second downlink polarisation using the first beam. For example, a second downlink signal can be transmitted in the corresponding first downlink polarisation and in the corresponding second downlink polarisation using the second beam. For example, l:th downlink signal can be transmitted in the corresponding first downlink polarisation and in the corresponding second downlink polarisation using the l:th beam.

In one or more example methods, the method 100 comprises receiving S106A, from the wireless device, the plurality of uplink signals.

The method 100 may comprise determining S108A the angular positioning of the wireless device based on the transmitted uplink characteristics of the uplink signals.

In one or more example methods, the one or more downlink signals are carried over wide beams. A uniform linear array (ULA) with M elements may form beams with an angular resolution of about π/M radians. Beams having, within a certain plane, a beamwidth of about π/M radians may herein be denoted as narrow beams within such plane. Beams having, within a certain plane, a beamwidth greater than twice π/M radians may herein be denoted as wide beams within such plane.

In one or more example methods, the one or more downlink signals comprise reference signals.

In one or more example methods, each of the one or more uplink signals is the same signal as the corresponding downlink signal. For example, each of the one or more uplink signals has characteristics which are the same or substantially the same as the corresponding downlink signal.

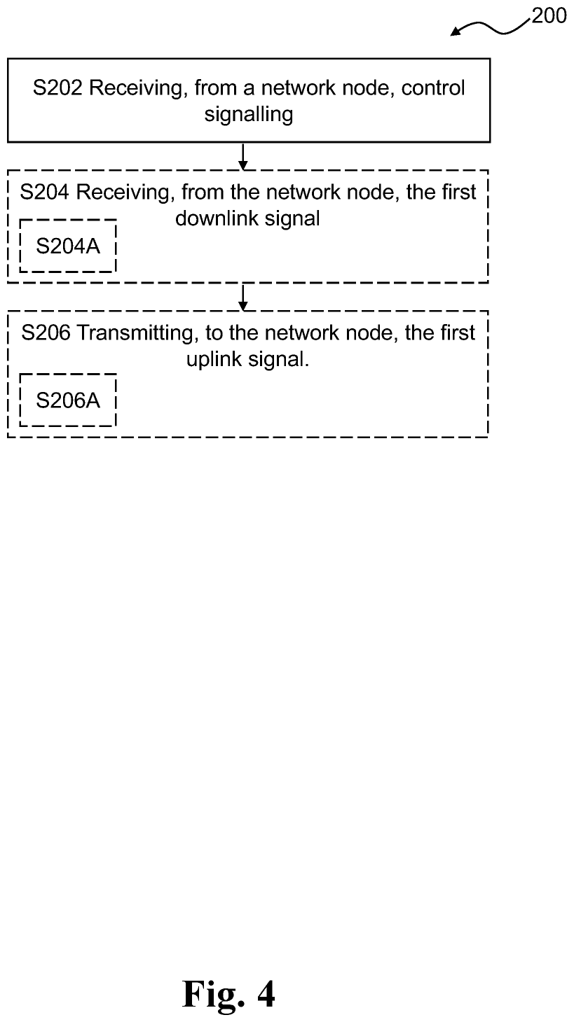

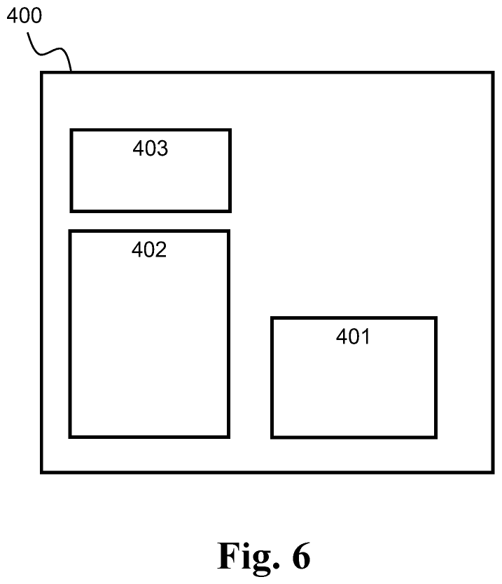

FIG. 4 shows a flow diagram of an example method 200, performed by a wireless device. The wireless device is the wireless device disclosed herein, such as wireless device 400 of FIG. 1, FIG. 2, and FIG. 6. The method 200 may be a method for angular positioning of a wireless device, such as for enabling an angular positioning of the wireless device, such as for enabling a network node to determine an angular positioning of the wireless device.

The method 200 comprises receiving S202, from a network node, control signalling indicating that, upon receiving a downlink signal from the network node, the wireless device is to respond by transmitting an uplink signal. The control signalling received in S202 may correspond to the control signalling transmitted in S102 of FIG. 3. In one or more examples, the control signalling received in S202 can be illustrated by 502 in FIG. 2. Control signalling can be in form of one or more of: a flag and one or more control messages. For example, the flag may be seen as an implicit signalling indicating to the wireless device that, upon receiving a downlink signal from the network node, the wireless device is to respond by transmitting an uplink signal. The one or more control messages can be indicating to the wireless device that, upon receiving a downlink signal from the network node, the wireless device is to respond by transmitting an uplink signal. The one or more control messages can include an information indicating to the wireless device that, upon receiving a downlink signal from the network node, the wireless device is to respond by transmitting an uplink signal.

The downlink signal may comprise a first downlink polarisation and a second downlink polarisation. In other words, the downlink signal may have a first downlink polarisation and a second downlink polarisation. The uplink signal may comprise a first uplink polarisation and a second uplink polarisation. Stated differently, the uplink signal may have a first uplink polarisation and a second uplink polarisation. For example, the network node can transmit the downlink signal in a first downlink polarisation and in a second downlink polarisation. For example, the wireless device can transmit the uplink signal in a first uplink polarisation and in a second uplink polarisation.

The downlink signal may have a measured downlink characteristic. The measured downlink characteristic may be seen as a characteristic, measured by the wireless device, performed on the downlink signal received by the wireless device. The measured downlink characteristic may be a characteristic as observed and/or seen by the wireless device. For example, the measured downlink characteristic is a characteristic representative of the downlink signal received by the wireless device. A signal (such as a downlink signal and/or an uplink signal) can include an amplitude and a phase, such as an amplitude and phase in each polarisation of the signal.

The measured downlink characteristic may comprise a downlink amplitude ratio between the amplitude of the downlink signal in the first downlink polarisation and the amplitude of the downlink signal in the second downlink polarisation. The measured downlink characteristic may comprise a downlink phase difference between the phase of the downlink signal in the first downlink polarisation and the phase of the downlink signal in the second downlink polarisation.

The uplink signal may have a transmitted uplink characteristic. The transmitted uplink characteristic may be seen as a characteristic of the uplink signal transmitted by the wireless device. For example, the transmitted uplink characteristic is a characteristic representative of the uplink signal transmitted by the wireless device.

The transmitted uplink characteristic may comprise an uplink amplitude ratio between the amplitude of the uplink signal in the first uplink polarisation and the amplitude of the uplink signal in the second uplink polarisation. The transmitted uplink characteristic may comprise an uplink phase difference between the phase of the uplink signal in the first uplink polarisation and the phase of the uplink signal in the second uplink polarisation. The transmitted uplink characteristic may be the same as the measured downlink characteristic.

In one or more example methods, the control signalling indicates that, upon receiving a plurality of downlink signals, comprising the downlink signal, from the network node, the wireless device is to respond by transmitting a plurality of uplink signals, comprising the uplink signal, each uplink signal of the plurality of uplink signals being associated with a corresponding downlink signal of the plurality of downlink signals.

For example, the plurality of downlink signals comprises a downlink signal, a second downlink signal, and optionally a third downlink signal, and optionally a fourth downlink signal, and optionally an l:th downlink signal. L is a positive integer.

For example, the plurality of uplink signals comprises an uplink signal, a second uplink signal, and optionally a third uplink signal, and optionally a fourth uplink signal, and optionally an l:th uplink signal. L is a positive integer.

Each downlink signal may comprise a first downlink polarisation and a second downlink polarisation. Each uplink signal may comprise a first uplink polarisation and a second uplink polarisation. Each downlink signal may have a first downlink polarisation and a second downlink polarisation. Each uplink signal may have a first uplink polarisation and a second uplink polarisation.

Each downlink signal may have a measured downlink characteristic. The measured downlink characteristic may comprise a downlink amplitude ratio between the amplitude of the downlink signal in the first downlink polarisation and the amplitude of the downlink signal in the second downlink polarisation. The measured downlink characteristic may comprise a downlink phase difference between the phase of the downlink signal in the first downlink polarisation and the phase of the downlink signal in the second downlink polarisation.

Each uplink signal may have a transmitted uplink characteristic. The transmitted uplink characteristic may comprise an uplink amplitude ratio between the amplitude of the uplink signal in the first uplink polarisation and the amplitude of the uplink signal in the second uplink polarisation. The transmitted uplink characteristic may comprise an uplink phase difference between the phase of the uplink signal in the first uplink polarisation and the phase of the uplink signal in the second uplink polarisation.

The transmitted uplink characteristic of each uplink signal may be the same as the measured downlink characteristic of the corresponding downlink signal.

In one or more example methods, the method 200 comprises receiving S204, from the network node, the downlink signal.

In one or more example methods, the method 200 comprises transmitting S206, to the network node, the uplink signal. For example, the wireless device may transmit S206, to the network node, the uplink signal in the first uplink polarisation and in the second uplink polarisation using one or more beams.

In one or more example methods, the method 200 comprises receiving S204A, from the network node, the plurality of downlink signals.

In one or more example methods, the method 200 comprises transmitting S206A, to the network node, the plurality of uplink signals. For example, the wireless device may transmit S206A, to the network node, each uplink signal of the plurality of uplink signals in the corresponding first uplink polarisation and in the corresponding second uplink polarisation using a corresponding beam. For example, the plurality of beams comprises a first beam, a second beam, and optionally a third beam, and optionally a fourth beam, and optionally an l:th beam.

For example, the network node may receive, from the wireless device, each uplink signal of the plurality of uplink signals in the corresponding first uplink polarisation and in the corresponding second uplink polarisation using a corresponding beam. For example, the plurality of beams comprises a first beam, a second beam, and optionally a third beam, and optionally a fourth beam, and optionally an l:th beam. For example, an uplink signal can be transmitted in the corresponding first uplink polarisation and in the corresponding second uplink polarisation using the first beam. For example, a second uplink signal can be transmitted in the corresponding first uplink polarisation and in the corresponding second uplink polarisation using the second beam. For example, the l:th uplink signal can be transmitted in the corresponding first uplink polarisation and in the corresponding second uplink polarisation using the l:th beam.

In one or more example methods, the one or more downlink signals are carried over wide beams.

In one or more example methods, the one or more downlink signals comprise reference signals.

In one or more example methods, each of the one or more uplink signals is the same signal as a corresponding downlink signal.

FIG. 5 shows a block diagram of an example network node 300 according to the disclosure. The network node 300 comprises memory circuitry 301, processor circuitry 302, and a wireless interface 303. The network node 300 may be configured to perform any of the methods disclosed in FIG. 3. The network node 300 may be configured to perform any of the methods disclosed herein. In other words, the network node 300 may be configured for angular positioning of a wireless device.

The wireless interface 303 can be configured to communicate with a wireless device, such as the wireless device disclosed herein, using a wireless communication system.

The network node 300 is configured to transmit, (such as via the wireless interface 303), to a wireless device, control signalling indicating to the wireless device that, upon receiving a downlink signal from the network node, the wireless device is to respond by transmitting an uplink signal.

The downlink signal may comprise a first downlink polarisation and a second downlink polarisation. The uplink signal may comprise a first uplink polarisation and a second uplink polarisation.

The downlink signal may have a measured downlink characteristic. The measured downlink characteristic may comprise a downlink amplitude ratio between the amplitude of the downlink signal in the first downlink polarisation and the amplitude of the downlink signal in the second downlink polarisation. The measured downlink characteristic may comprise a downlink phase difference between the phase of the downlink signal in the first downlink polarisation and the phase of the downlink signal in the second downlink polarisation.

The uplink signal may have a transmitted uplink characteristic. The transmitted uplink characteristic may comprise an uplink amplitude ratio between the amplitude of the uplink signal in the first uplink polarisation and the amplitude of the uplink signal in the second uplink polarisation. The transmitted uplink characteristic may comprise an uplink phase difference between the phase of the uplink signal in the first uplink polarisation and the phase of the uplink signal in the second uplink polarisation.

The transmitted uplink characteristic may be the same as the measured downlink characteristic.

In one or more example network nodes, the control signalling indicates to the wireless device that, upon receiving a plurality of downlink signals, comprising the downlink signal, from the network node, the wireless device is to respond by transmitting a plurality of uplink signals, comprising the uplink signal, each uplink signal of the plurality of uplink signals being associated with a corresponding downlink signal of the plurality of downlink signals.

Each downlink signal may comprise a first downlink polarisation and a second downlink polarisation. Each uplink signal may comprise a first uplink polarisation and a second uplink polarisation.

Each downlink signal may have a measured downlink characteristic. The measured downlink characteristic may comprise a downlink amplitude ratio between the amplitude of the downlink signal in the first downlink polarisation and the amplitude of the downlink signal in the second downlink polarisation. The measured downlink characteristic may comprise a downlink phase difference between the phase of the downlink signal in the first downlink polarisation and the phase of the downlink signal in the second downlink polarisation.

Each uplink signal may have a transmitted uplink characteristic. The transmitted uplink characteristic may comprise an uplink amplitude ratio between the amplitude of the uplink signal in the first uplink polarisation and the amplitude of the uplink signal in the second uplink polarisation. The transmitted uplink characteristic may comprise an uplink phase difference between the phase of the uplink signal in the first uplink polarisation and the phase of the uplink signal in the second uplink polarisation.

The transmitted uplink characteristic of each uplink signal may be the same as the measured downlink characteristic of the corresponding downlink signal.

The network node 300 is optionally configured to transmit (such as via the wireless interface 303 and/or processor circuitry 302), to the wireless device, the downlink signal. The network node 300 is configured to transmit (such as via the wireless interface 303 and/or processor circuitry 302), to the wireless device, the plurality of downlink signals.

Optionally, the network node 300 is configured to receive (such as via the wireless interface 303 and/or processor circuitry 302), from the wireless device, the uplink signal. The network node 300 may be configured to receive (such as via the wireless interface 303 and/or processor circuitry 302), from the wireless device, the plurality of uplink signals.

Optionally, the network node 300 is configured to determine an angular positioning of the wireless device based on the transmitted uplink characteristic of the uplink signal. In one or more example network nodes, the network node 300 is configured to determine the angular positioning of the wireless device based on the transmitted uplink characteristics of the uplink signals.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution—enhanced Machine Type Communication, LTE-M, millimeter-wave communications, such as millimeter-wave communications in licensed bands, such as device-to-device millimeter-wave communications in licensed bands, Non-Terrestrial Networks and sidelink communication.

Processor circuitry 302 is optionally configured to perform any of the operations disclosed in FIG. 3 (such as any one or more of S104, S104A, S106, S106A, S108, S108A). The operations of the network node 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the network node 300 may be considered a method that the network node 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 5). Memory circuitry 301 is considered a non-transitory computer readable medium.

Memory circuitry 301 may be configured to store the angular positioning in a part of the memory.

FIG. 6 shows a block diagram of an example wireless device 400 according to the disclosure. The wireless device 400 comprises memory circuitry 401, processor circuitry 402, and a wireless interface 403. The wireless device 400 may be configured to perform any of the methods disclosed in FIG. 4. The wireless device 400 may be configured to perform any of the methods disclosed herein.

In other words, the wireless device 400 is configured for enabling angular positioning of the wireless device by a network node.

The wireless device 400 may be configured to receive, (such as via the wireless interface 403), from a network node, control signalling indicating that, upon receiving a downlink signal from the network node, the wireless device is to respond by transmitting an uplink signal.

The downlink signal may comprise a first downlink polarisation and a second downlink polarisation. The uplink signal may comprise a first uplink polarisation and a second uplink polarisation

The downlink signal may have a measured downlink characteristic. The measured downlink characteristic may comprise a downlink amplitude ratio between the amplitude of the downlink signal in the first downlink polarisation and the amplitude of the downlink signal in the second downlink polarisation. The measured downlink characteristic may comprise a downlink phase difference between the phase of the downlink signal in the first downlink polarisation and the phase of the downlink signal in the second downlink polarisation.

The uplink signal may have a transmitted uplink characteristic. The transmitted uplink characteristic may comprise an uplink amplitude ratio between the amplitude of the uplink signal in the first uplink polarisation and the amplitude of the uplink signal in the second uplink polarisation. The transmitted uplink characteristic may comprise an uplink phase difference between the phase of the uplink signal in the first uplink polarisation and the phase of the uplink signal in the second uplink polarisation.

The transmitted uplink characteristic may be the same as the measured downlink characteristic.

In one or more example wireless devices, the control signalling indicates that, upon receiving a plurality of downlink signals, comprising the downlink signal, from the network node, the wireless device is to respond by transmitting a plurality of uplink signals, comprising the uplink signal, each uplink signal of the plurality of uplink signals being associated with a corresponding downlink signal of the plurality of downlink signals.

Each downlink signal may comprise a first downlink polarisation and a second downlink polarisation. Each uplink signal may comprise a first uplink polarisation and a second uplink polarisation.

Each downlink signal may have a measured downlink characteristic. The measured downlink characteristic may comprise a downlink amplitude ratio between the amplitude of the downlink signal in the first downlink polarisation and the amplitude of the downlink signal in the second downlink polarisation. The measured downlink characteristic may comprise a downlink phase difference between the phase of the downlink signal in the first downlink polarisation and the phase of the downlink signal in the second downlink polarisation.

Each uplink signal may have a transmitted uplink characteristic. The transmitted uplink characteristic may comprise an uplink amplitude ratio between the amplitude of the uplink signal in the first uplink polarisation and the amplitude of the uplink signal in the second uplink polarisation. The transmitted uplink characteristic may comprise an uplink phase difference between the phase of the uplink signal in the first uplink polarisation and the phase of the uplink signal in the second uplink polarisation.

The transmitted uplink characteristic of each uplink signal may be the same as the measured downlink characteristic of the corresponding downlink signal.

The wireless device 400 is configured to communicate with a network node, such as the network node disclosed herein, using a wireless communication system.

In one or more example wireless devices, the wireless device 400 is configured to receive (such as via the wireless interface 403 and/or processor circuitry 402), from a network node, the downlink signal. The wireless 400 is configured to receive (such as via wireless interface 403 and/or processor circuitry 402), from a network node, the plurality of downlink signals.

In one or more example wireless devices, the wireless device 400 is configured to transmit (such as via the wireless interface 403 and/or processor circuitry 402), to the network node, the uplink signal. The wireless device 400 is configured to transmit (such as via the wireless interface 403 and/or processor circuitry 402), to the network node, the plurality of uplink signals.

The wireless interface 403 is optionally configured for wireless communications via a wireless communication system, such as a 3GPP system, such as a 3GPP system supporting one or more of: New Radio, NR, Narrow-band IoT, NB-IoT, and Long Term Evolution—enhanced Machine Type Communication, LTE-M, millimeter-wave communications, such as millimeter-wave communications in licensed bands, such as device-to-device millimeter-wave communications in licensed bands, Non-Terrestrial Networks and sidelink communication.

The wireless device 400 is optionally configured to perform any of the operations disclosed in FIG. 4 (such as any one or more of S204, S204A, S206, S206A). The operations of the wireless device 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the wireless device 400 may be considered a method that the wireless device 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 5). Memory circuitry 401 is considered a non-transitory computer readable medium.

Memory circuitry 401 may be configured to store information (such as control signalling indicating that, upon receiving a downlink signal from the network node 300, the wireless device 400 is to respond by transmitting an uplink signal) in a part of the memory.

FIGS. 7A-7B are graphs illustrating example performances of the angular positioning of the wireless device according to this disclosure. Results of the Cramer-Rao Lower Bound, CRLB, are illustrated on the y-axis of FIG. 7A-7B (expressed in square-degrees). The y-axis gives a lower bound (achievable at high SNR) of the Mean-Square Error, MSE, in square-degrees. The x-axis represents the angular positioning. In other words, x-axis represents the angular position of the wireless device. The y-axis represents the response at the network node.

The legend gives the center locations of the beams for curves 701, 702, 703. For 701, the number of beams, L, is 3. For 702, the number of beams, L is 7. For 703, the number of beams, L, is 13.

FIG. 7A shows the CRLB results for wide beams. FIG. 7B shows the CRLB results for narrow beams (such as pencil beams).

The performance of the disclosed methods and devices can depend on the antenna responses B_{k,l}(α). The Cramer-Rao Lower Bound, CRLB, is an upper bound to the precision of the estimation of the angular positioning. Stated differently, the CRLB is a lower bound on the MSE for unbiased estimation techniques. The Maximum Likelihood, ML, estimation techniques meet the CRLB asymptotically in the SNR.

CRLB can allow estimation or determination of a parameter vector that contains information about the precision of the angular positioning. CRLB may lead to determining an error between an estimated angular positioning and the angular positioning.

The CRLB can be calculated by standard formulas as long as the observations are complex Gaussian. The observations are complex Gaussian whether γ is known or not known. The Fisher information reacts to B_{k,l}(α) as

$${\vert \frac{\partial {B}_{k , l} ( α )}{\partial α} \vert}^{2} .$$

The antenna response can change rapidly over α to achieve high performance.

The devices and methods disclosed herein may provide a set of suitable antenna responses, such as the set of beams designed to have a wide beamwidth. For example, the antenna responses may have the desired properties. For example, the antenna responses are (i) wide if seen across both polarisations, and (ii) rapidly changing per polarisation, in both, amplitude and phase, over a. In other words, beam designs are available to provide an improved angular positioning performance, such as an accurate angular positioning.

In one or more examples, the number of beams is relatively small, such as less than 10. For example, when the number of beams is small, the beams may be wide.

In one or more examples, wide beams are not used, and the number of beams is larger than 10.

FIG. 7A-7B provide numerical results on the CRLB with unknown γ. The noise density N₀=100 and a uniform linear array, ULA, with 16 antennas is used. For a wide beam, a prototype array of size 4 is used. FIGS. 7A-7B show CRLB for |γ|=1 (where the phase is not relevant to be considered). FIG. 7A shows the CRLB results for wide beams. FIG. 7B shows the CRLB results for standard pencil beams.

FIG. 7A shows that, when the real angular positioning is about +/−80 degrees, the estimate or determination of the angular positioning of the wireless device may be erroneous, which can thereby lead to an incorrect angular positioning of the wireless device. FIG. 7A shows that for real angular positioning values between, e.g., −60 and 60 degrees, the CRLB is low, which may indicate that the estimated angular positioning values have a low error, that is, a suitable accuracy of the angular positioning of the wireless device.

For example, curve 702 shows 7 wide beams that can achieve satisfactory estimation performance for a wide range of angular positions of the wireless device. Curve 701 shows that using more beams might not be necessary, as this does not entail substantial improvements in the CRLB values.

FIG. 7B shows curves 704 and 705 using narrow beams. FIG. 7B shows that the accuracy of the estimation of the angular positioning of the wireless device may be inferior to that of the examples of FIG. 7A.

Examples of methods and products (network node and wireless device) according to the disclosure are set out in the following items:
Item 1. A method, performed by a network node, the method comprising:
   transmitting, to a wireless device, control signalling indicating to the wireless device that, upon receiving a downlink signal from the network node, the wireless device is to respond by transmitting an uplink signal;
wherein the downlink signal comprises a first downlink polarisation and a second downlink polarisation, and the uplink signal comprises a first uplink polarisation and a second uplink polarisation;
   wherein the downlink signal has a measured downlink characteristic, the measured downlink characteristic comprising a downlink amplitude ratio between the amplitude of the downlink signal in the first downlink polarisation and the amplitude of the downlink signal in the second downlink polarisation, and the measured downlink characteristic comprising a downlink phase difference between the phase of the downlink signal in the first downlink polarisation and the phase of the downlink signal in the second downlink polarisation;
   wherein the uplink signal has a transmitted uplink characteristic, the transmitted uplink characteristic comprising an uplink amplitude ratio between the amplitude of the uplink signal in the first uplink polarisation and the amplitude of the uplink signal in the second uplink polarisation, and the transmitted uplink characteristic comprising an uplink phase difference between the phase of the uplink signal in the first uplink polarisation and the phase of the uplink signal in the second uplink polarisation;
   wherein the transmitted uplink characteristic is the same as the measured downlink characteristic.
Item 2. The method of item 1, wherein the control signalling indicates to the wireless device that, upon receiving a plurality of downlink signals, comprising the downlink signal, from the network node, the wireless device is to respond by transmitting a plurality of uplink signals, comprising the uplink signal, each uplink signal of the plurality of uplink signals being associated with a corresponding downlink signal of the plurality of downlink signals;
   wherein each downlink signal comprises a first downlink polarisation and a second downlink polarisation, and each uplink signal comprises a first uplink polarisation and a second uplink polarisation;
   wherein each downlink signal has a measured downlink characteristic, the measured downlink characteristic comprising a downlink amplitude ratio between the amplitude of the downlink signal in the first downlink polarisation and the amplitude of the downlink signal in the second downlink polarisation, and the measured downlink characteristic comprising a downlink phase difference between the phase of the downlink signal in the first downlink polarisation and the phase of the downlink signal in the second downlink polarisation;
   wherein each uplink signal has a transmitted uplink characteristic, the transmitted uplink characteristic comprising an uplink amplitude ratio between the amplitude of the uplink signal in the first uplink polarisation and the amplitude of the uplink signal in the second uplink polarisation, and the transmitted uplink characteristic comprising an uplink phase difference between the phase of the uplink signal in the first uplink polarisation and the phase of the uplink signal in the second uplink polarisation;
   wherein the transmitted uplink characteristic of each uplink signal is the same as the measured downlink characteristic of the corresponding downlink signal.
Item 3. The method of any one of the preceding items, the method comprising:
   transmitting, to the wireless device, the downlink signal,
   receiving, from the wireless device, the uplink signal,
   determining an angular positioning of the wireless device based on the transmitted uplink characteristic of the uplink signal.
Item 4. The method of items 2 and 3, the method comprising:
   transmitting, to the wireless device, the plurality of downlink signals,
   receiving, from the wireless device, the plurality of uplink signals,
   determining the angular positioning of the wireless device based on the transmitted uplink characteristics of the uplink signals.
Item 5. The method of any one of the preceding items, wherein the one or more downlink signals are carried over wide beams.
Item 6. The method of any one of the preceding items, wherein the one or more downlink signals comprise reference signals.
Item 7. The method of any one of the preceding items, wherein each of the one or more uplink signals is the same signal as the corresponding downlink signal.
Item 8. A method, performed by a wireless device, the method comprising:
   receiving, from a network node, control signalling indicating that, upon receiving a downlink signal from the network node, the wireless device is to respond by transmitting an uplink signal;
      wherein the downlink signal comprises a first downlink polarisation and a second downlink polarisation, and the uplink signal comprises a first uplink polarisation and a second uplink polarisation;
      wherein the downlink signal has a measured downlink characteristic, the measured downlink characteristic comprising a downlink amplitude ratio between the amplitude of the downlink signal in the first downlink polarisation and the amplitude of the downlink signal in the second downlink polarisation, and the measured downlink characteristic comprising a downlink phase difference between the phase of the downlink signal in the first downlink polarisation and the phase of the downlink signal in the second downlink polarisation;
      wherein the uplink signal has a transmitted uplink characteristic, the transmitted uplink characteristic comprising an uplink amplitude ratio between the amplitude of the uplink signal in the first uplink polarisation and the amplitude of the uplink signal in the second uplink polarisation, and the transmitted uplink characteristic comprising an uplink phase difference between the phase of the uplink signal in the first uplink polarisation and the phase of the uplink signal in the second uplink polarisation;
      wherein the transmitted uplink characteristic is the same as the measured downlink characteristic.
Item 9. The method of item 8, wherein the control signalling indicates that, upon receiving a plurality of downlink signals, comprising the downlink signal, from the network node, the wireless device is to respond by transmitting a plurality of uplink signals, comprising the uplink signal, each uplink signal of the plurality of uplink signals being associated with a corresponding downlink signal of the plurality of downlink signals;
   wherein each downlink signal comprises a first downlink polarisation and a second downlink polarisation, and each uplink signal comprises a first uplink polarisation and a second uplink polarisation;
   wherein each downlink signal has a measured downlink characteristic, the measured downlink characteristic comprising a downlink amplitude ratio between the amplitude of the downlink signal in the first downlink polarisation and the amplitude of the downlink signal in the second downlink polarisation, and the measured downlink characteristic comprising a downlink phase difference between the phase of the downlink signal in the first downlink polarisation and the phase of the downlink signal in the second downlink polarisation;
   wherein each uplink signal has a transmitted uplink characteristic, the transmitted uplink characteristic comprising an uplink amplitude ratio between the amplitude of the uplink signal in the first uplink polarisation and the amplitude of the uplink signal in the second uplink polarisation, and the transmitted uplink characteristic comprising an uplink phase difference between the phase of the uplink signal in the first uplink polarisation and the phase of the uplink signal in the second uplink polarisation;
   wherein the transmitted uplink characteristic of each uplink signal is the same as the measured downlink characteristic of the corresponding downlink signal.
Item 10. The method of any one of items 8 to 9, the method comprising:
   receiving, from the network node, the downlink signal,
   transmitting, to the network node, the uplink signal.
Item 11. The method of items 9 and 10, the method comprising:
   receiving, from the network node, the plurality of downlink signals,
   transmitting, to the network node, the plurality of uplink signals.
Item 12. The method of any one of items 8 to 11, wherein the one or more downlink signals are carried over wide beams.
Item 13. The method of any one of the preceding items, wherein the one or more downlink signals comprise reference signals.
Item 14. The method of any one of the preceding items, wherein each of the one or more uplink signals is the same signal as a corresponding downlink signal.
Item 15. A network node comprising memory circuitry, processor circuitry, and a wireless interface, wherein the network node is configured to perform any of the methods of items 1 to 7.
Item 16. A wireless device comprising memory circuitry, processor circuitry, and a wireless interface, wherein the wireless device is configured to perform any of the methods of items 8 to 14.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that Figures comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value.

The various example methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a network node, the method comprising:
transmitting, to a wireless device, control signalling indicating to the wireless device that, upon receiving a downlink signal from the network node, the wireless device is to respond by transmitting an uplink signal; wherein the downlink signal comprises a first downlink polarisation and a second downlink polarisation, and the uplink signal comprises a first uplink polarisation and a second uplink polarisation;
wherein the downlink signal has a measured downlink characteristic, the measured downlink characteristic comprising a downlink amplitude ratio between the amplitude of the downlink signal in the first downlink polarisation and the amplitude of the downlink signal in the second downlink polarisation, and the measured downlink characteristic comprising a downlink phase difference between the phase of the downlink signal in the first downlink polarisation and the phase of the downlink signal in the second downlink polarisation;
wherein the uplink signal has a transmitted uplink characteristic, the transmitted uplink characteristic comprising an uplink amplitude ratio between the amplitude of the uplink signal in the first uplink polarisation and the amplitude of the uplink signal in the second uplink polarisation, and the transmitted uplink characteristic comprising an uplink phase difference between the phase of the uplink signal in the first uplink polarisation and the phase of the uplink signal in the second uplink polarisation;
wherein the transmitted uplink characteristic is the same as the measured downlink characteristic.

2. The method of claim 1, wherein the control signalling indicates to the wireless device that, upon receiving a plurality of downlink signals, comprising the downlink signal, from the network node, the wireless device is to respond by transmitting a plurality of uplink signals, comprising the uplink signal, each uplink signal of the plurality of uplink signals being associated with a corresponding downlink signal of the plurality of downlink signals;
wherein each downlink signal comprises a first downlink polarisation and a second downlink polarisation, and each uplink signal comprises a first uplink polarisation and a second uplink polarisation;
wherein each downlink signal has a measured downlink characteristic, the measured downlink characteristic comprising a downlink amplitude ratio between the amplitude of the downlink signal in the first downlink polarisation and the amplitude of the downlink signal in the second downlink polarisation, and the measured downlink characteristic comprising a downlink phase difference between the phase of the downlink signal in the first downlink polarisation and the phase of the downlink signal in the second downlink polarisation;
wherein each uplink signal has a transmitted uplink characteristic, the transmitted uplink characteristic comprising an uplink amplitude ratio between the amplitude of the uplink signal in the first uplink polarisation and the amplitude of the uplink signal in the second uplink polarisation, and the transmitted uplink characteristic comprising an uplink phase difference between the phase of the uplink signal in the first uplink polarisation and the phase of the uplink signal in the second uplink polarisation;
wherein the transmitted uplink characteristic of each uplink signal is the same as the measured downlink characteristic of the corresponding downlink signal.

3. The method of claim 1, the method comprising:
transmitting, to the wireless device, the downlink signal,
receiving, from the wireless device, the uplink signal,
determining an angular positioning of the wireless device based on the transmitted uplink characteristic of the uplink signal.

4. The method of claim 2, the method comprising:
transmitting, to the wireless device, the downlink signal,
receiving, from the wireless device, the uplink signal,
determining an angular positioning of the wireless device based on the transmitted uplink characteristic of the uplink signal,
transmitting, to the wireless device, the plurality of downlink signals,
receiving, from the wireless device, the plurality of uplink signals,
determining the angular positioning of the wireless device based on the transmitted uplink characteristics of the uplink signals.

5. The method of claim 1, wherein the one or more downlink signals are carried over wide beams.

6. The method of claim 1, wherein the one or more downlink signals comprise reference signals.

7. The method of claim 1, wherein each of the one or more uplink signals is the same signal as the corresponding downlink signal.

8. A method, performed by a wireless device, the method comprising:
receiving, from a network node, control signalling indicating that, upon receiving a downlink signal from the network node, the wireless device is to respond by transmitting an uplink signal;
wherein the downlink signal comprises a first downlink polarisation and a second downlink polarisation, and the uplink signal comprises a first uplink polarisation and a second uplink polarisation;
wherein the downlink signal has a measured downlink characteristic, the measured downlink characteristic comprising a downlink amplitude ratio between the amplitude of the downlink signal in the first downlink polarisation and the amplitude of the downlink signal in the second downlink polarisation, and the measured downlink characteristic comprising a downlink phase difference between the phase of the downlink signal in the first downlink polarisation and the phase of the downlink signal in the second downlink polarisation;
wherein the uplink signal has a transmitted uplink characteristic, the transmitted uplink characteristic comprising an uplink amplitude ratio between the amplitude of the uplink signal in the first uplink polarisation and the amplitude of the uplink signal in the second uplink polarisation, and the transmitted uplink characteristic comprising an uplink phase difference between the phase of the uplink signal in the first uplink polarisation and the phase of the uplink signal in the second uplink polarisation;
wherein the transmitted uplink characteristic is the same as the measured downlink characteristic.

9. The method of claim 8, wherein the control signalling indicates that, upon receiving a plurality of downlink signals, comprising the downlink signal, from the network node, the wireless device is to respond by transmitting a plurality of uplink signals, comprising the uplink signal, each uplink signal of the plurality of uplink signals being associated with a corresponding downlink signal of the plurality of downlink signals;
wherein each downlink signal comprises a first downlink polarisation and a second downlink polarisation, and each uplink signal comprises a first uplink polarisation and a second uplink polarisation;
wherein each downlink signal has a measured downlink characteristic, the measured downlink characteristic comprising a downlink amplitude ratio between the amplitude of the downlink signal in the first downlink polarisation and the amplitude of the downlink signal in the second downlink polarisation, and the measured downlink characteristic comprising a downlink phase difference between the phase of the downlink signal in the first downlink polarisation and the phase of the downlink signal in the second downlink polarisation;
wherein each uplink signal has a transmitted uplink characteristic, the transmitted uplink characteristic comprising an uplink amplitude ratio between the amplitude of the uplink signal in the first uplink polarisation and the amplitude of the uplink signal in the second uplink polarisation, and the transmitted uplink characteristic comprising an uplink phase difference between the phase of the uplink signal in the first uplink polarisation and the phase of the uplink signal in the second uplink polarisation,
wherein the transmitted uplink characteristic of each uplink signal is the same as the measured downlink characteristic of the corresponding downlink signal.

10. The method of claim 8, the method comprising:
receiving, from the network node, the downlink signal,
transmitting, to the network node, the uplink signal.

11. The method of claim 9, the method comprising:
receiving, from the network node, the downlink signal,
transmitting, to the network node, the uplink signal,
receiving, from the network node, the plurality of downlink signals,
transmitting, to the network node, the plurality of uplink signals.

12. The method of claim 8, wherein the one or more downlink signals are carried over wide beams.

13. The method of claim 8, wherein the one or more downlink signals comprise reference signals.

14. The method of claim 8, wherein each of the one or more uplink signals is the same signal as a corresponding downlink signal.

15. A network node comprising memory circuitry, processor circuitry, and a wireless interface, wherein the network node is configured to perform the method of claim 1.

16. A wireless device comprising memory circuitry, processor circuitry, and a wireless interface, wherein the wireless device is configured to perform the method of claim 8.
